(19) United States
(12) Patent Application Publication
(10) Pub. No.: US 2013/0151637 A1
(43) Pub. Date: Jun. 13, 2013

(54) SYSTEM AND METHODS FOR FILTERING AND ORGANIZING EVENTS AND ACTIVITIES

(71) Applicant: findandremind.com, Los Angeles, CA (US)

(72) Inventor: Anthony Bedikian, Los Angeles, CA (US)

(73) Assignee: FINDANDREMIND.COM, Los Angeles, CA (US)

(21) Appl. No.: 13/677,195

(22) Filed: Nov. 14, 2012

Related U.S. Application Data
(60) Provisional application No. 61/570,288, filed on Dec. 13, 2011.
(60) Provisional application No. 61/570,289, filed on Dec. 13, 2011.
(60) Provisional application No. 61/570,290, filed on Dec. 13, 2011.
(60) Provisional application No. 61/622,436, filed on Apr. 10, 2012.

(51) Int. Cl. H04L 29/08

(52) U.S. Cl. CPC H04L 67/22
USPC 709/206

(57) ABSTRACT

Embodiments described herein relate generally to social networking, and more particularly, to methods to filter and manage various events and group activities. In one embodiment, a system for filtering and managing events and activities is disclosed. The system may include a hardware processor configured to manage a site, allow users to create user areas within the site, allow users to create events and designate invitees through the user area, automatically generate and send invitations to invitees and to monitor the status of these invitations, allow users to receive invitations to other events, integrate all events into a single calendar, and automatically send e-mail to users regarding various event updates.

### RELATED APPLICATIONS INFORMATION

This application claims the benefit under §119(e) of U.S. Provisional Application Ser. No. 61/570,288, filed Dec. 13, 2011 and entitled “Systems and Methods for Filtering and Organizing Events and Activities,” and U.S. Provisional Application Ser. No. 61/570,289, filed Dec. 13, 2011 and entitled “Systems and Methods for Filtering and Organizing Events and Activities Using an Online Sign Up Sheet,” and U.S. Provisional Application Ser. No. 61/570,290, filed Dec. 13, 2011 and entitled “Systems and Methods for Filtering and Organizing Events and Activities Using an Auto-Invite Feature,” and U.S. Provisional Application Ser. No. 61/622,436, filed Apr. 10, 2012 and entitled “Systems and Methods for Filtering and Organizing Events and,” all of which are incorporated herein by reference in their entirety as if set forth in full.

### BACKGROUND

1. Technical Field

The embodiments described herein are related to online social networking, and more particular to methods to filter and manage family activities that allow tight security and flexibility to manage various groups and activities.

2. Related Art

It is becoming harder and harder to manage family activities in today's world. Often Dad is working all the time to support the family, and Mom is torn in a million different directions by all the kids, trying to manage school, school events, after school events, play dates, sports and other weekend activities, etc. Often a family can become overwhelmed with friends, events, and activities all “coming and going” like a revolving door in their lives. With millions of families constantly in need of entertaining their children with play dates and organizing activities for singing, dancing, soccer, basketball, carpooling, helping with school work, child care and everything in between there is a need for a tool that families can use to help organize all of these activities.

Every family in America faces these daily challenges in one way or another. Accordingly, any such tool should help make these daily stresses more manageable, allow families to network, interact and coordinate activities, and help parents organize their lives, get away from the madness, and even occasionally enjoy a night out or just a day of freedom. Ideally such a tool would provide a way to harness the power of the internet and Mobile Phone to organize and streamline many of these stressful activities, allow families to join forces and coordinate/communicate with other each other, and quickly reach a vast network of household helpers, all in one spot.

Moreover, such a tool should also allow for security and identity protection that can be easily managed, but is also robust. Since the information at issue can be sensitive family information, such security is a necessity. Also, since not everyone in a typical family is tech savvy, such a tool will need to be easy to use and very intuitive.

### SUMMARY

Systems and methods for managing, filtering, creating and inviting contacts to events are described herein. The systems and methods include auto-invite features that manage invitation and follow up, online sign up processes, radius map search functions, and integration of all functions on a single dashboard.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example system in accordance with one embodiment;

FIG. 2 is an example screen shot of a user dashboard that can be displayed by the authority 101 included in the system of FIG. 1; and

FIGS. 3-6 are example screen shots of various speed button displays in accordance with certain embodiments.

### DETAILED DESCRIPTION

Provided here are embodiments that describe a tool that comprises a highly “organized” social network (micro social networks) and scheduling platform geared toward today's busy families that offers a slew of family event planning and interaction tools and access to a vast network of high quality home service providers. The tool can be used to coordinate play dates for kids, carpools, study groups, parties, build social groups, and get valuable access to quality child services (tutors, sitters, nannies, etc.) and home care services (housekeepers, pet sitters, etc.) via both mobile phone app and internet, and avoid email clutter (i.e. the dozens of emails for one school activity) in one's inbox by going to a centralized location for all family communication and scheduling needs.

As will be explained Moms, Dads and kids can create their own “Circles” or “Clouds” and “Events” to communicate/coordinate schedules, plan activities, text requests to each other, all on the fly. Additionally, the tool can provide easy access to a database of high quality home care service providers with full profiles (and background checks from LexisNexis, etc.), who benefit from an easy and affordable avenue to market their services to a customer base of subscribers in the social network. Relieves families from wasting valuable time scheduling all their daily activities and household needs (and relief from extra phone calls while all the kids are screaming!), and gives home service providers exposure to a vast customer base in great need of their services.

The tool can act like a “virtual home assistant”, highly valuable when both parents work yet can plan their home life with just a few clicks online. Also, organizations such as schools and churches can create their own clouds to coordinate fundraisers, member events, etc. and have their own “theme” page for their clouds and sub-clouds (i.e. Archdiocese of Los Angeles cloud, and each church as a sub-cloud, easy communication and organization of activities from top down).

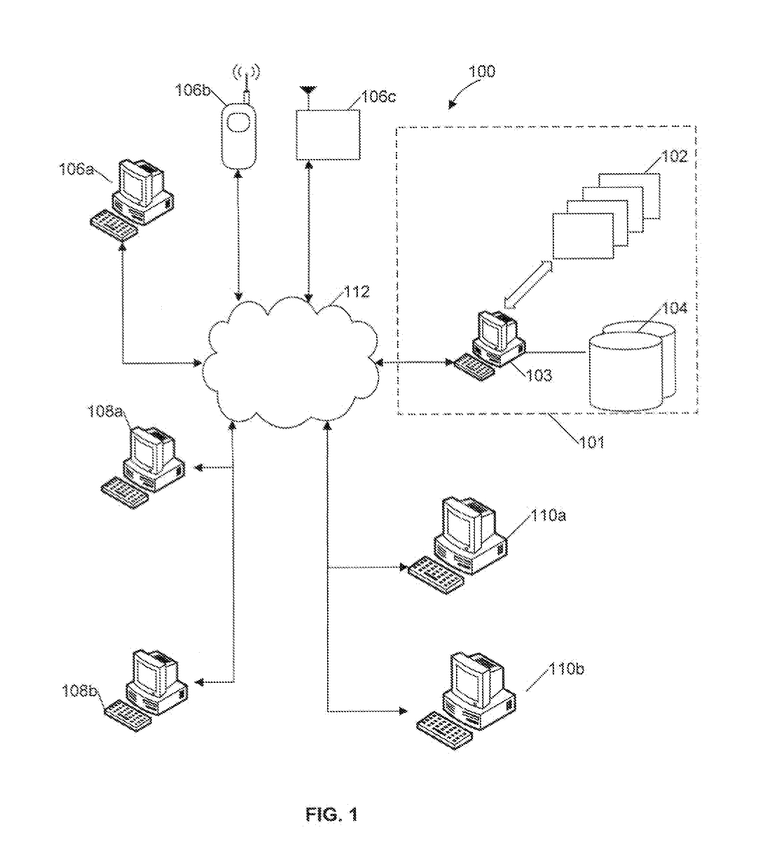

FIG. 1 is a diagram illustrating an example system 100 that can include a tool such as described above an in more detail below. At the core of system 100 is authority 101, which comprises all of the resources, hardware and software needed to carry out the processes, functions, features, etc., described herein. In particular, authority 101 can comprise a server 103 that can be configured, among other things some of which are described herein, to host a website that users and organizations can access through their terminal devices 106 and 108 respectively. Authority 101 can also comprise various programs, applications, filters, algorithms, schedulers, communication functions, etc., (collectively functions 102) needed to perform the functions described, such as managing and creating clouds and events, calendar maintenance and integration, reminders, communication, etc. Authority 101 can also include databases 104 configured to store user data related to the tool.

It will be understood that server 103 can comprise one or more servers, routers, processors, co-processors, digital signal processors, communication engines, user interfaces, etc., as required to implement the systems and methods described herein. These various resources can be located in a single location or can be spread across multiple locations. Similarly, databases 104 can be located in a single location or multiple locations or even implemented, at least partially as a cloud resource. The term cloud as used here refers to a model of networked online storage where data is stored on virtualized pools of storage, which are generally hosted by third parties, as opposed to its use in relation to the functions provided by authority 101 described in more detail below.

Users can access authority 101 using various terminal types such as a computer, laptop, mobile device, tablet, etc., designated here as devices 106a-c. Using these various devices 106a-c, users can access and use the site hosted by server 103, receiver invites, reminders, and generally manage these important family functions. As noted above, various organizations or entities can also access the site to create events and clouds, send invitations, etc. These entities are generally designated as terminals 108a and 108b. In addition, various services, entities, etc., can be tied into authority 101 to allow access to service providers, background checks thereon, etc. These entities are generally designated as terminals 110a and 110b.

The functions 102 can include Group Links that enable a user to create private groups. Each Group Link can have its own private Home Page. Great for fundraiser groups to discuss events, for classrooms to post homework or discuss specific class topics, activity group discussions, carpool or play date planning, etc. Provides an organized way to group conversations and events for quick and easy finding, viewing and communicating.

Functions 102 can also include e-Invitations and Announcements that allow a user to invite people to a birthday party, baby shower, a fundraiser, a family get-together, announce a school event, etc., and can provide integrated RSVP system and reminders. In certain embodiments, the user can choose from tons of themes, and customize invitation “cards”.

Functions 102 can also include a play dates streamline process for finding play dates for kids and Pitch In or Fill In functions that allow a user to create signup sheets to recruit other users to help out with any activity (a school carnival, a church/temple fundraiser event, a potluck, donation item signup for charity, teacher assistant signup, class readers, any activity). Moreover, the activities can be fully integrated into the user's calendar and reminder system.

Functions 102 can also include a Carpools function that allows the user to create signup sheets to organize carpools with other families the user is connected with. Again, the carpools can be fully integrated into your calendar and reminder system and a Dynamic Calendar that allows the user to track all events, communications, etc., with a quick look (with visual icons and color coding), and just a click away to view your Events, Invitations, To-dos, and Signup Sheets.

Functions 102 can also include a Message Center that can allow the user to communicate with contacts and receive all your reminders in one organized place making it easier to find all information quickly with the message filtering system. The user can search by message type, category, who sent it, etc. with just a click.

Functions 102 can also include blogs that can act like private micro-message boards for any topic. This can be great for fundraiser planning, homework posting, after-school activity discussions, casually planning carpools or play dates, just about anything.

Functions 102 can also include a To-dos function that reminds the user and others about important things to-do. This function can be fully integrated into the calendar and reminder system. In certain embodiments the user can assign to themselves or someone else, and receive alerts when tasks are completed.

Functions 102 can also include an integrated Maps Built into all Invitations and Signup Sheets so the user always know where they are going as well as Integrated Photo Albums that allow the user to share photos right on their event invitations and Group Link home pages.

The functions 102 can also include robust searching/filtering capability that allow the user to find all important events and messages by Category, Type, whom its from, keyword, and many other criteria.

Many of the functions described can be handled via the use of clouds, which is described in more detail below. The registration page for families can include a drop-down database search functionality for cities, schools and churches during registration process to create “initial clouds” for the school and church, then search for members (by name of Mom or Dad) to request invites to setup, e.g., “your kid's play circle” or “carpool circle”, or “soccer team cloud” Events after registration. Enter names of parents and kids (ages), email address, home address, and cell phone number, for initial registration, then when logged in our site searches for nearest school and church for user to choose from and join their school/church cloud.

Parents can also create accounts for their dependents—List of family members at top of dash. Can click on for each user to switch to their view by entering their own username and password. In certain embodiments, only parents can do this to check on their kids' content. Kids can have their own login.

Thus, every user can have their own user profile. The user can opt to display information on a field-by-field basis, to maximize their privacy options. Further, the user profile will contain a “Contact this user” link to send a private message to that user, only if the user has opted to be contacted.

Every user can have their friend (“buddy”) list to grow by inviting others, but in many implementations there won't be any other Facebook-like functions (no “wall”, etc.). This allows users to keep their friends independent of their clouds and events for ease of inviting to later events, cloud creation, etc.

Any many implementations, users are not publicly searchable on the site by name. Users can only search for others within their own private clouds (including clouds they've been invited to). The only exception is that users can search for each other within their own, e.g., church and school clouds, but only if the user joined their school and church cloud during the registration process. In certain implementations, if a user doesn't join their church or school cloud during registration or first login, they will then need to “request membership” from another member of that cloud.

In certain embodiments, when users refer/invite a friend to the site (via Refer a Friend/Find a Buddy button on dash), an email is sent to their external email address to join site. The users are then added to each other's buddy list. If a member wants to find another person who is already a member, they can send this same link to the other member's external email address, which would link each other as friends and be added to each other's buddy list and they could then interact on the site. Again, this requires the knowledge of the other person's external email address. Users can invite an existing member as a friend by Buddy ID # (every member gets an ID at registration), which user would need to obtain from the other existing member by other means (by external email, conversation, etc). They would enter the Buddy ID# and invite that user as a friend and get connected. Finally, users can recommend an existing friend to another friend they already have.

In certain embodiments, the only other way members could see other members that are not yet friends or in their private clouds is when people are invited to an Event, and see the invitation list (if the invite sender opted to show the list, which can be turned off by the sender). In this case, invitees can opt to show their full name or first name/last initial, and can also opt to turn on/off their ability to be contacted.

With the above options, every member remains anonymous until they are connected to each other.

It should be noted that users can have the ability to import contacts from Gmail, Hotmail, etc. For registered users, each user will get a friend request to join the sender's buddy list. For unregistered users, each email address will receive an invitation request to join the site, then be prompted to become buddies

Registered members can also be allowed to live chat with anyone on their friend list/buddy list with “online” status. This is a private 1-on-1 chat between two people.

As noted, clouds and events can be used by each user to manage their activities. In certain embodiments, there can be two cloud “types”—PUBLIC and PRIVATE. Public clouds can be searchable by anyone and may or may not require approval to join the cloud (decided by the author of that cloud). Public clouds can exist in a public “clouds directory” with filters and other search options (including filter by location, type, etc). The directory can provide some basic info about the cloud, a link to view the cloud details, and some type of “membership” link to either request membership or join the cloud, depending on approval requirements.

Schools/churches are examples of these types of public clouds, and are no different than any other public clouds; however, one of the filters in the “clouds directory” can be a cloud type, and, e.g., “School” and “Church” would appear in this drop-down.

Private clouds are generally not searchable and therefore not listed in public “clouds directory.” The only way to join (or even see) these clouds is if an administrator of the private cloud invites the user. For example, immediately following user registration, the user can be redirected to the public “clouds directory”, and recommendations can be offered based on the location the user just entered during registration on the previous step: “We recommend CHURCH X and SCHOOL Y based on your location”. Since they are in the public directory, then they can immediately join/request membership at that time.

In certain embodiments, within each cloud group, there can be a list of users in that group (who have opted to be visible). This list can have filters and search options in order to help locate cloud members of interest. This list can also have an “add to friends list” link or something similar, which would send a friend request to the user.

Administrators of the clouds have access to a different list of users, which shows all users in the cloud (visible or not), with options to remove them or give them administrative privileges in the cloud. These lists of users can appear in both public and private clouds, and of course would only be visible to members of the cloud.

The third place users can be listed is in the details of an event. The invitation list would be displayed if the author of the invitation (the sender) opted to show the list. This list can display all users who have been invited, and whether or not they accepted the invitation (if the user has opted to be visible).

Nowhere else will users be searchable/visible, other than in buddy lists.

There can be options to add users from the buddy list to event invitation lists, as well as cloud invitation lists. Further, when user is referred to the site, the use can automatically become “buddies” with the referrer upon account creation. Users can send friend requests to other users by providing either a valid email or User ID, as long as that email/ID is associated with a site user account. A single “buddy list,” instead of multiple lists can be used in order to make it possible to add these friend request functions in numerous places without having to specify which “list” the request is referring to. Further, just because a user is in some “list” doesn't mean they have access to all of the information about the user. We can design more granular access control this way.

Events and Clouds can be treated independently and both can require a directory, i.e. Event Bank and Cloud Bank. When users are invited to an event, the user is given the option to create a cloud with that list of people and name that cloud. The purpose of the cloud step is when the user wants to create a more permanent group specifically for those invites for future events and general communications, or when this event is recurring for a long period of time.

If no group is created, then the invitees are treated like a temporary group just for that event (invitees are tied together only by this event) which basically goes away after the event transpires. Invitees can communicate with that event group by posting blogs (or just Messages if blogs are too difficult to code) regarding event if admin has made it read/write. If read only, then only admin can broadcast additional messages to group, but invitees can still organize a cloud with each other to organize a carpool, etc (if admin has turned on the name list, otherwise invitees would see each others names, or opt to show only first name/last initial, or turn on/off their ability to be contacted).

When creating an event, the user chooses an event type, from a pre-defined list (e.g. “school function”, “carpool”, etc).

In certain embodiments, events can therefore be created independently from Clouds. Thus, users can have the ability to create an event independently first, then invite people (or other existing clouds), then give option to save this list of invites as a new cloud, then send the invite.

A “Content Bank” (aka “Cloud/Event Bank”) can be included to allow users to easily find all Clouds/Events/To-dos/Blogs/Messages, and Broadcasts in List Format . . . (user can check more than one category to tag content when creating it). Further a Master Search function can be included (in “Cloud/Event/To-do Bank”, or “Content Bank”)—to allow a user to find all Clouds, Events, To-dos, Blogs, and individual members when users choose a particular Date, Name (person, event, cloud, blog, to-do)—i.e. start typing name and all choices automatically shown), Category, or Sub-category (i.e. from list of categories user chooses “school activity”, and all clouds, events, To-dos, and Blogs names are listed that are tagged by “school activity”; or choose Aug. 12, 2010, and all Clouds, Events, To-dos, and Blogs names created on Aug. 12, 2010 are listed).

The functions 102 can include event and cloud generation wizards to make creation of events and clouds easy and intuitive.

With respect to the event wizard, four primary Event Speed Buttons can be included as well as a “create a Cloud” button. These four Buttons can include: “Parties/Activities/Announcements”, “Find a Play date”, “Catch a Ride”, “Need Volunteers”, and then the “Create a Cloud” button, which can all be displayed on a user dashboard, an example of which is described in more detail below.

When a wizard is engaged, the wizard screen pops up (background of dashboard remains behind it and visible) and users can then create an event as described below. Each Event created can be saved in the user's “Content Bank”, organized by “type”, “past events”, “up and coming events”, “Events you've created”, “Events you've been invited to”. The following is an example wizard process”

I. Click “Party/Activity/Announcement” Speed Button

For any type of Party or Group Get-together (B-days, family get-togethers, school fundraisers, soccer practice, etc.)

Step 1) “Would you like to invite folks to an Event” or

“Just make an Announcement”

Step 2) “What Type of event are we looking at?”

a) choose from list of categories—see “Content Bank” description for Event Types/Categories

b) “Great, let's name the event”—give it a name

Step 3) “Time to alert some folks!” or “Time to get the word out!”

a) “Wanna make it really easy and invite a cloud you already have?—choose from list of existing clouds

b) Or, “Wanna choose your invites one at a time”—choose existing members by searching for them in “Content Bank”, buddy list, enter member ID, or enter email addresses for non-members, or download from your Gmail/Hotmail/Yahoo contacts—Need “Content Bank” on this screen to choose invites (user can drag clouds or members to the invite list?)

c) Option to save this group of people as a Cloud for future get-togethers—

“Name the cloud”, enter cloud type, read or read/write permission

Step 4) “Let's schedule the event”

Choose whether it's a one time ordeal (i.e. b-day party), or recurring (i.e. soccer practice), or custom schedule (“dates and times all mixed up”)

Enter date/times/ and description of Event

step 5) “Let's check out the details before we send it”—Link to

### Party/Activity Ticket—See Later in Document

Next, the invitation screen can pop up (similar to Evite) showing what the invitation will look like that invitees will see when they click on the invite link (with area to accept/decline/maybe and an invite counter (number accept, decline, maybe), # of guests brought by invitee, and area to enter short message). The invite screen includes signup fields for the non-member invitees to join the site first before being allowed to accept/decline invite (members are auto-logged in if click on link in external email), and box to enter short message. The invite screen also shows all invited people who have accepted, declined, maybe (can be turned on/off by invitor/owner, users can opt to show full name or first name/last initial, and opt in/out of being contacted if clicked on by other invitees on the ticket.

If just “an announcement” was chosen in Step 1, “floating page/bulletin” can be created for all invites to access by clicking on the URL sent to their email (and/or in alert box for existing members), but doesn't include accept field or invite counter.

The user can also choose a reminder email/alert frequency (i.e. 1 day before event, etc.) and can select Save Ticket (queued for sending at any time)—housed in area for queued Events on Dash until sent.

The user can then select “Send”, which will cause an alert to be sent to members, email announcement (with URL linked to “invite page”) sent to non-members (emails/texts will be sent to members as well if they opt for external email alerts in their account defaults. Members will see an alert in their dashboard).

The “event” can then be saved as a “floating page or RSVP” that all people invited to the event can reference anytime by clicking on the event in their calendar (or click the link they received in their email), and change their status anytime if desired. If recurring, then the “floating page” shows all the dates line by line and any notes.

Every Event ticket created can have its own read/write URL (same url sent in email alert)—just like the URL to a Google doc which can be updated by any allowed user—accessible via email link, calendar, or Content Bank

Invitees can opt to show only their first name on the invite list, or show only a portion of their profile, and allow/disallow other invitees to contact them, but are encouraged to leave themselves “contactable” for group interaction (assuming the sender allowed the list to be viewable in the first place).

This invite will be pushed to the Calendar, for both the invitor/owner and invitees when they signup for membership (whether or not they've accepted so invitees have a reminder on their calendar, but shows up as a different color or has asterisk, etc.) In certain embodiments, the use can at this point now talk to these folks via the family command center (dashboard)”—“message them, text them, blog them, or post a To-do List”—just choose the “event name” or “cloud name” in any quadrant.

An example process for creating a play date can be as follows:

Click “Find a Play date” Speed Button

Step 1) “Let's find a friend to play with”

a) “let's find your Play date the old-fashioned way”—just choose from existing members by searching for them in existing personal clouds, or search in your school/church clouds, buddy list, enter member ID, enter email addresses for non-members (“get 'em signed up!”), or download from your Gmail/Hotmail/Yahoo contacts—Need “Content Bank” on this screen to choose invites (user can drag clouds or members to the invite list?)

b) Or, “Try out the Auto Invite Feature?”—“You'll like this . . . ”—see below

Step 2) “Let's schedule the play date?”

a) Enter date/time/ and location of play date

step 3) “Let's check out the details before we alert your buddy”—Link to

### Play Date Ticket—See Screenshot Later in Document

a) If a) is chosen in Step 1)

The play date ticket pops up for review with play date details, showing what the invitee will see when he/she clicks on the “invite” link in their external email (or in Notification area on dash for members), with button to accept or decline, registration field for non-members (members are auto-logged in if click on link in external email), and area to enter short response message

Choose reminder email/alert frequency (i.e. 1 hour before event, etc.)

Print button to print the play date ticket if desired

Save Ticket (queued for sending at any time), housed in area for queued Events on Dash until sent

Hit “Send”—alert sent to member, email announcement (with URL) sent to non-members (emails will be sent to members as well if they opt for external email alerts in their account defaults).

The “event” is saved as a “floating bulletin page or RSVP” that the invitor/invitee can reference anytime by clicking on the event in their calendar (or click the link they received in their email if they weren't a member), and change their status anytime if desired.

every play date ticket created has its own read/write URL (same url sent in email alert)—just like the URL to a Google doc which can be updated by any allowed user—accessible via email link, calendar, or Content bank

this invite will be pushed to the Calendar, for both the invitor/owner and invitees when they signup for membership (whether or not they've accepted so invitees have a reminder on their calendar, but shows up as a different color or has asterisk, etc.

The play date alert email includes invitor/owner's name and “you've been invited to a play date”, click link to see play date ticket, play date ticket pops up with all play date info, with registration fields for non-members to join site, then click accept/decline button

b) If b) is chosen in Step 1)—AUTO INVITE FEATURE

“Pick a few friends and invite them one by one, just sit back and relax until someone accepts”—no one sees your other invitees.

Choose number of play date spots to fill (i.e. for group play date choose 2 or more)—if 2 or more spots, then sender can turn on/off view of the accepting members on the ticket.

Choose your potential play dates (via Content Bank, buddy list, or enter emails), then drag them up or down to put them in order of preference.

Choose time between invites (i.e. 30 minutes, 1 hour, etc.)

Same Play date ticket screen pops up as above for review,

Save Ticket (queued for sending at any time), housed in area for queued Events on Dash until sent

hit SEND

An invite is sent one by one until someone accepts, filling play date spots; if an invite expires after 30 minutes has elapsed for example, then an email is sent to that invitee stating “play date request has expired. We'll try again next time”. Once play date spots are filled, sender is notified (or if any changes, i.e. accepting invitee cancels).

The user can now communicate with these folks via the family command center (dashboard)”—“message them, text them, blog them, post a To-do List”—just choose the “event name” or “cloud name” in any quadrant.

An example process for creating a car pool can be as follows:

Click “Catch a Ride” Speed Button

Step 1) “Time to alert some folks!” or “Time to get the word out!”

a) “Wanna make it really easy and invite a cloud you already have?—if Yes, everyone in the cloud is invited, choose the cloud name from your list, then step 3. “It's usually a good idea to blog or message your cloud first about the Carpool invite that's coming.”

b) Or, “Wanna choose your invites one at a time?”—create a list by choosing existing members by searching for them in Content Bank, or enter email addresses for non-members, or download from your Gmail/Hotmail/Yahoo contacts. OR . . .

Advanced Map Search—Directors/organizers/coaches/coordinators may have pre-created clouds of people for their organization (i.e. Mrs. Gervis class, singing class instructor, church membership, etc.) so members in their clouds can find each other via map search (like Google Maps), so anyone in the cloud can coordinate their own carpools depending on where they live—this map is populated with existing members of the cloud (only viewable by these cloud members if opt in), and populates new members once they signup—users can turn on/off their map location to a cloud, or to an individual, and only members of your chosen clouds can see your location.

c) Option to save this carpool group as a Cloud (if not already) for future carpools

“Name the cloud”, choose cloud category, read or read/write

d) “Let's give the ride a name”—name it, Next . . .

Step 2) “Let's schedule this ride!”

Choose one time ride, recurring, or custom schedule (“dates/times all mixed up”)

Enter the following details

Date, Description of event, destination, time of pickup to, location of pickup to, time of return

Number of cars

How many passengers allowed?

step 3) “Let's checkout the carpool ticket before we send it”—link to

### Carpool Ticket—See Screenshot Later in Document

“Carpool ticket window” shows details above, box for car 1, car 2, etc. with buttons for both drivers to “take the seat”, and buttons for each passenger to click to “Fill the seat”, and short message box for each participant

Privacy choice—turn on/off whether ticket shows invitee list

Choose reminder email/alert frequency (i.e. 1 day before event, etc.)

Print button to print the carpool ticket if desired, and for invitees to print when they gain access

Save Ticket (queued for sending at any time), housed in area for queued Events on Dash until sent

Hit “Send”—alert sent to members, email announcement (with URL linked to “carpool ticket”) sent to non-members (emails will be sent to members as well if they opt for external email alerts in their account defaults. Members will also see an alert number in notification area in their dashboard).—email shows name of invitor/owner, and choices to accept or decline

The “carpool” is saved as a “floating carpool ticket or RSVP” that the invitor/owner and invitees can reference anytime by clicking on the event in their calendar (or click the link they received in their email), and fill out the fields for driver or passenger—every ticket created has its own read/write URL (same url sent in email alert)—just like the URL to a Google doc which can be updated by any allowed user—accessible via email link, calendar, or Content bank in dashboard

Invitees can opt to show only their first name on the invite list, or show only a portion of their profile, and allow/disallow other invitees to contact them, but are encouraged to leave themselves “contactable” for group interaction (assuming the sender allowed the list to be viewable in the first place)

This invite will be pushed to the Calendar, for both the invitor/owner and invitees when they signup for membership (whether or not they've accepted so invitees have a reminder on their calendar, but shows up as a different color or has asterisk, etc).—user can delete if desired

The carpool alert email includes invitor/owner's name (and email address) and “you've been invited to a carpool”, click link to see carpool ticket, carpool ticket pops up with all carpool info, with registration fields for non-members, and login fields for members.

click button to fill the seat for driver and/or passenger, or if not interested just do nothing (when invitees click on buttons to fill seats they see their list of family members names to choose from, or add family member if desired)

Any changes on the Carpool ticket later will send an alert message to the invitor/owner and invitees (unless alert is turned off)

An example process for creating a volunteer list can be as follows:

Click “Need Volunteers” Speed Button

Step 1) “Time to alert some folks!” or “Time to get the word out!”

a) “Wanna make it really easy and invite a cloud you already have?—if Yes, everyone in the cloud is invited, choose the cloud name from your list, then step 3. “It's usually a good idea to blog or message your cloud first about the Volunteer invite that's coming.”

b) Or, “Wanna choose your invites one at a time”—create a list by choosing existing members by searching for them in existing personal clouds, search in your school/church cloud, Buddy list, typing in their Member ID, or enter email addresses for non-members, or download from your Gmail/Hotmail/Yahoo contacts.—Need “Content Bank” on this screen to choose invites (user can drag clouds or members to the invite list?)

c) Or, “Wanna try out the Auto Invite Feature?”—“You'll like this . . . ”—see below

d) Option to save this Volunteer group as a Cloud (if not already) for future carpools

“Name the cloud”, enter cloud type, read or read/write

e) “Let's give the Event a name”—name it

Step 2) “When/Where do we need these folks?”

Choose one time event, recurring, or custom schedule (“dates/times all mixed up”)

Enter dates/times/repeat frequency (if recurring need start and end dates, and which day of week to repeat from)

Enter location

Enter number of jobs needed to be filled (i.e. might be for a carnival and need 4 carnival booths filled, so choose 4)

Step 3) “Let's spell-out the event details”

Shows page with list of volunteer jobs (i.e. four rows if chose 4 jobs above)

Each row has empty box to enter name of job, choose number of volunteers needed for that job, comment box, and box to choose dates (dates pre-populated from last step, but can choose individually or select all), button to add a job to the list.

step 4) “Let's checkout the Volunteer ticket before we send it”—see link to Volunteer Ticket

“Volunteer ticket window” shows rows by date, with name of job and comment, and button for invitees to “take the job”

Privacy choice—turn on/off whether ticket shows invitee list to invitees, or whether invitees see who filled the positions

Choose reminder email/alert frequency (i.e. 1 day before event, etc.)

Print button to print the carpool ticket if desired, and for invitees to print when they gain access

Save Ticket (queued for sending at any time), housed in area for queued Events on Dash until sent

Hit “Send”—alert sent to members, email announcement (with URL linked to “volunteer ticket”) sent to non-members (emails will be sent to members as well if they opt for external email alerts in their account defaults. Members will also see an alert number in alert box in their dashboard).—email shows name of invitor/owner, and choices to accept or decline

The Event is saved as a “floating volunteer ticket or RSVP” that the invitor/owner and invitees can reference anytime by clicking on the event in their calendar (or click the link they received in their email), and volunteer for the job (or remove themselves) and add a comment—every ticket created has its own read/write URL (same url sent in email alert)—just like the URL to a Google doc which can be updated by any allowed user—accessible via email link, calendar, or Content bank (“Content Bank”) in dashboard

Invitees can opt to show only their first name/last initial on the invite list, or show only a portion of their profile, and allow/disallow other invitees to contact them, but are encouraged to leave themselves “contactable” for group interaction (assuming the sender allowed the list to be viewable in the first place)

this Invite will be pushed to the Calendar, for both the invitor/owner and invitees when they accept and/or signup for membership (whether or not they've accepted so invitees have a reminder on their calendar, but shows up as a different color or has asterisk, etc.)

b) If c) is chosen in Step 1)—Auto Volunteer Search—sends same volunteer ticket, but one at a time to invitee list—no one sees your other invitees

“Pick a few recruits and invite them one by one, just sit back and relax until someone accepts”

Choose number of volunteer spots to fill (i.e. 2 substitute teachers needed)

Choose your potential volunteers (via cloud search, individual search, or enter emails), then drag them up or down to put them in order of preference.

Choose time between invites (i.e. 24 hrs, 48 hrs, etc.)

Same Volunteer ticket screen pops up as above for review

Save Ticket (queued for sending at any time), housed in area for queued Events on Dash until sent

Hit Send

A Volunteer ticket is sent one by one until someone accepts, filling volunteer spots; if an invite expires after 24 hrs has elapsed for example, then an email is sent stating “volunteer request has expired. We'll try again next time”

An example process for the cloud wizard can be as follows:

Click “Create a Cloud” Speed Button—to create groups of people for micro social networks, or for future events—screen pops up (background of site still viewable)

screen pops up (background of dashboard remains behind it and visible)

Step 1) “Let's organize this cloud”

a) “What type of Cloud would you like to create?”

choose from school related, church related, family, activity group, purely social, user defined—see “Content Bank” description earlier in document for categories

b) “Great, let's name the cloud”—give it a name

Step 2) “Time to bring some folks in!” or “Time to get the word out!”

a) “Wanna make it really easy and invite another cloud you already have?—if Yes, everyone in the cloud is invited, just choose the cloud name from your cloud bank

b) Or, “Let's pick some people by hand”—create a list by choosing existing members by searching for them in existing personal clouds, search in your school/church cloud, Buddy list, typing in their Member ID, or enter email addresses for non-members, or download from your Gmail/Hotmail/Yahoo contacts.—Need “Content Bank” on this screen to choose invites (user can drag clouds or members to the invite list?)

Step 3) “Let's decide who can touch this cloud”

choose from “read only” or “read/write”, and “public” or “private”

[public=“everyone on the site can find via their cloud bank, join it, and search for people in it (this type of cloud will be restricted to only certain types of members, like schools, churches, businesses, or possibly individuals with ConnectionMinder.com to pre-approve)

private=“only people invited can see this cloud in their cloud bank and search for each other, and no one else”—most clouds will have this setting

read only=“only the “owner” of the cloud can communicate, members of the cloud can only view”

read/write=“anyone in the cloud and both view and communicate”

i.e. with “public read only” anyone on the site can see but only the owner can do the talkin'“, or with a “private read/write” only invitees can see the cloud in their cloud bank, but both the owner and invitees can talk in it”

Step 4) “Let's check out the cloud details and launch it”

summary screen showing info above, and ability to change details

then click “Launch it” button

“Just so you know, you can now communicate with these folks via your family command center (dashboard)”—“message them, text them, blog them, post a To-Do List”—just choose the “event name” or “cloud name” in any quadrant and chat away!

invitees who are non-members need to respond to the invites from the same email address that the invitor entered during the invite (or enter their email address)

activation email link sent to newly signed up members' external email to activate account for added security

Cloud types can include:

Home/Family (for close family/friends)

Emergency Contact

School (for school administrators only)

categories (for families to create, linked to primary school cloud, viewable by entire school): Classroom, Fundraiser, After School Activities

Church/Synagogue (for church administrator only)

categories (for families to create, linked to primary church cloud, viewable by entire church): Sunday School class, Fundraiser, Church Activity

Purely Social (for friends groups, various topic discussions, i.e. Moms and Teens, etc)

Activity Group

categories: Sports activity, The Arts (dancing, singing, etc.), School Clubs, Kid's Camp, Leisure (fishing, boating, surfing, horseback riding, etc.)

Event types can include:

Personal Reminder (for user to enter into their calendar manually, like in iCal, Google Calendar, etc.)

Party/Get-together/Bulletin

categories: Family, Birthday, Anniversary, Wedding, Baby Shower, New Baby, Holiday Party, Graduation, Funeral, Charity, Award Ceremony, Church, School, Work, “At the Park”

Play date

Carpool

categories: school activity, church activity, sports activity, Party,

Work

Need Volunteers

categories: school activity, church activity, sports activity, Party, Charity, Work

Sports activity (practice, games, etc.)—Category for all above Events

sub-categories: baseball, basketball, soccer, football, lacrosse, hockey, tennis, volleyball, track and field, softball, golf, bowling, gymnastics, cheerleading, wrestling, martial arts, cycling, running, swimming, diving, rowing, boating, horseback-riding

To-do types can include:

Personal Notepad—to jot down quick things—can be saved with a date, or saved as “static”

list of “stickies” (icons) for user to drag to their notepad for the day

(OR TO THEIR CALENDAR)

B-day, Doctor visit, Dentist appt, First day of school, school pics, Party, No School, Half Day, team party, school party, church party, teacher conference, open house, last day of school, Vacation, play date, sleepover, carpool, sports game, sports practice, eye doctor, dance class, gymnastics class, swim lessons, singing class, school event, church event, vet, meeting, haircut, grocery shop, call someone

Emergency contacts: Fire department, hospital, Police, Alarm company, close relative

Medical: Doctor, Dentist, Eye doctor

Favorite Restaurants:

Family/Household

categories: Vacation planning, house cleaning, yard work, doctor appointment (or dentist), vet, car maintenance

checklists (house cleaning): take out trash, clean dishes, do laundry, mop floors, clean bathrooms, make the beds, clean windows

checklists (vacations):

Errands

categories: Grocery shopping, dry cleaning, drop off kids, pickup kids, doctor visits, carwash, get gas, haircut, shoe repair

checklists (grocery shopping): eggs, cheese, bread, milk, yogurt, cottage cheese, canned goods, steak, chicken, pork, shrimp, fish, produce

Activities

categories: Vacations, Kids' activities, Parents' activities, Sports activity, school activity, church activity

Work

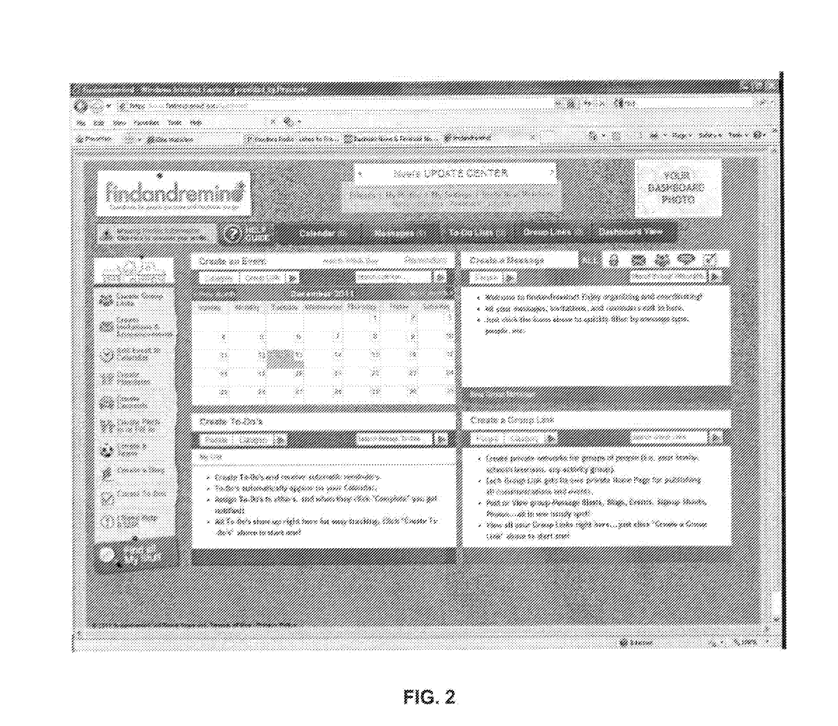

As noted, the user can have a dashboard display when they access the site. FIG. 2 is a screen shot illustrating and example dash board display. Many of the functions features described herein can be access via the dashboard. The dashboard or update center is a central feature of the site.

The Update Center is the user's “dashboard” or “command center” where they can perform several communication and organizational functions in one convenient place, solving the problem of forcing users having to join multiple different websites for various organizing/networking functions. The function suite includes: Calendar, Message Center, Private Groups, Blogs, To-Do's, Play date Finder, Carpool signup sheets, volunteer signup sheets, and Need Help ASAP finder, Friends list.

All functions can be accessible on one screen via the Update Center, adding to the convenience factor. The Calendar, Message Center, To-Do Lists, and Private Groups (Group Links) quadrants can be shown under “Dashboard View” which allows the user to see all of their updates for these functions in a single glance.

The dashboard or update center allows for the integration of all functions: The Calendar is automatically fed all event/signup and To-do information (name, date/time, etc.) that the user creates or accepts. When an e-Invitation/Announcement, Carpool or Volunteer signup sheet, Play date, or To-do is created by the user, the system automatically places an icon (for quick visual reference) and link on the calendar which takes the user directly to that Event or signup sheet screen when clicked. When a user receives an invitation to an event or signup sheet, if they accept the invitation (or take a spot in the signup sheet), the event is automatically populated on their calendar. They can also choose to simply add it to their calendar (and decide later) by clicking the “Add to Calendar” button on the event or signup sheet (this process avoids the user's calendar being filled up with undesired events that they receive from others).

The Message Center automatically shows all events, signup sheet, and To-do related messages (reminders, invitations, etc.) with corresponding “visual icons” for ease of recognition. These messages are also sent to the users' email address listed in their user profile (which can be turned off anytime). Private and Group Link messages are also sent/received to/from other users from here.

The To-do list section allows users to create/view To-do's for themselves as well as assign to others (and auto-show on calendar as described above) directly from their Update Center. When a user assigns a To-do to another user, the other user receives a note in their Message Center (as well as their external email) and it also appears on their calendar. When that user checks the “complete” box on the To-do screen, the sender of the To-do automatically receives a notification message in their Message Center (and external email) that the To-do is complete, and also can see the completed To-do in their To-do quadrant on their dashboard.

The Group Link (Private Groups) section allows the user to create/view private groups directly from their Update Center, and view them in simple list format with a glance. Clicking on the group link names takes the user directly to that group link home page, which is like a “hub” for that particular group. This group home page integrates all the group members, their messages, e-Invitations/Announcements, Carpool and Volunteer signup sheets, Blogs, and Photo Albums pertaining only to the particular group for ease of communication and referencing of information in a central place.

The primary challenge of the update center is firstly assembling all of the system information in one place, and secondly ensuring that the user has correct permissions to view the data we wanted to present. Secondary challenges included web server performance. A standard Drupal use 100 k of css and requires 1.5 seconds+ to load. However, with this data intensive presentation, 800 kb of css cab be required, which can result in up to 10 seconds per page load.

Thus, to display the information, quadrants for each of the main topic areas are created, and a miniature layout is presented with icons and graphics to help the user process the information at glance. For permissions, we the Access Control List (“ACL”) can be sued to pre-tag all information with view and edit permissions for each user. To increase the performance, all sql queries, used memcache can be optimized, and the css and javascript can be kept to a minimum.

In certain embodiments, whenever user clicks on one of the quadrants to initiate new content, they're prompted to choose a person, cloud, or event prior to entering a message, blog, or to-do list (in other words, every bit of info in each quadrant is tagged to either the user, a person, event, or cloud before creating content for easy recall and filtering later). Or just to view existing content in any quadrant, they click on the filtering box next to each quadrant which produces a pop-up containing clouds, events, and individuals (“Content Bank”).

Each quadrant on the dash will have the ability to filter by Event, Cloud, and person. For example, users can choose from Event names for a particular section of dashboard (Calendar, To-do, Communication, blog sections), and that section will filter by the Event name (if there was nothing in that quadrant related to the Event, then it shows nothing.

Each quadrant on the dash will have the ability to filter by Event, Cloud, and person independently of the other quadrants. A “master filter” button to filter all quadrants by the same type of content will also be available.

Calendar section—User can enter their own personal Events for only themselves, just like in iCal or Google Calendar; the window that pops up to enter the Event also has Speed Button choices mentioned above to create more sophisticated events. Say you're already a member of the “soccer cloud”, click on filter button, popup window with Events/Clouds/Individual Members (“Content Bank”), choose “soccer cloud” and calendar switches to “soccer cloud” calendar and see events in that cloud or post new events.

All special events can be listed on the calendar by name, and the name can be just a link to these URLs, and when clicked on a popup window to this event screen. This will save real estate in the calendar, as well as the dashboard as a whole, because it's just a popup. It also keeps the user on their dashboard. The ability to enter regular/informal events can be included too (just like in Google, iCal, Outlook, etc).

For creation of special Events (with invitations and/or associated with clouds, like b-day parties, play dates, carpools, etc.), a Speed Button can be located on the dashboard (pop-up with Wizard style event creation) instead of going to separate page on the website to create an invite. Then the events are populated in the calendar section of invitor/invitees (invitees, who are already members, should see this event in their calendars even if they haven't accepted yet so they are always reminded that they need to respond—maybe have that event as a different color, or with an asterisk, etc.). These events are shown by name in the calendar, and are links (URLs) to the invite “tickets”.

Blog/message board section (easy group communication/community discussions within clouds)—For families to create discussion groups, or who want to post informal invitations or events for play dates, carpools, etc. Or for organizations to post a bulletin of events to members of their cloud.—To view blogs from a cloud, Click on Filter button in Blog quadrant, popup window comes up with Events/Clouds/Individual Members (Content Bank), choose “Calvary Church cloud” for example, and blog screen changes to that cloud and only see posts for that blog. “Alerts” tab shows number of new messages (shown as small number at top right of button). Click on filter button, and each cloud box shows number of new (not yet viewed) blog messages.

When creating a blog, a user can choose individuals to send the blog to (in addition to existing clouds), then add step to group these people in a cloud (currently only clouds are a choice to send a blog to). Users can also have the ability to rate blog entries when adding comments to them. For each cloud, show number of unread blog posts since last view.

Communication section—for messaging, texting, emailing member to member, or member to group—i.e. Click on Filter button, popup window with Events/Clouds/Individual Members (Content Bank), choose “Horse Riding” cloud, and quadrant shows all texts/messages sent/received for only that. Only members of a particular cloud can see these communications. Simply drill down to individual's name within a cloud and text/email (only individuals can see each other's messages). “Alerts” box shows number of new messages (shown as small number at top right of button). Click on “Alert box” to view senders, click on sender to view message. Or Click on quadrant filter button (Content Bank popup), and each cloud/event tab shows number of new (not yet viewed) messages.

Message can be where the user actually enters their message (as opposed to a separate page to enter the message and just being posted on the dash)—To whom the message goes is determined when the user clicks in the message box at bottom of quadrant, and get a pop-up window showing clouds, event groups, or person to direct the message to, then the message would be entered at the bottom of the quadrant, similar to how a Chat box works (or if not enough room to enter message there, can click in dialogue box and a popup window comes up similar to what's currently on the message page in the sandbox.

In certain embodiments, a link to an external email client can be provided that opens the external email client in a new window or modal frame. The link is generated dynamically based on the user's registered email address (e.g. registering with a Gmail address provides an external link to Gmail).

To-do List section—For families to enter all their daily errands or tasks associated with a particular event (can tie to calendar, to clouds, or to Events), and Click on Filter button, popup window with Events/Clouds/Individual Members (Content Bank) to filter To-dos.

An example To-do list can include the following:

Basic Notepad for users' personal To-do's (with “post-it/stickies” user interface, see description below)

To-do Categories (Household, Work Related, Kid's activity, etc)

Entire To-do List (assignable to others)

Sub Tasks (individually assignable to others, admin determines whether assignor marks tasks as completed, or assignee can)

Checklists

Start date/Time (if any)

End date/Time (if any)—same as due date?

Recurring dates ability for To-dos/Tasks

Completed or not

Priority level of To-do's and sub tasks

Tags (to Events, Clouds, to individuals)—searchable by these tags on To-do quadrant

Publishable to individuals, Clouds, or Event Groups

To-do/Task organizer (sorts by name of To-do, start date, end date, Completed, not completed, priority level, etc.)

Integrated with calendar (shows up on Calendar as a link to To-do)

Alerts sent to task assignees

Personal Notepad can include a predetermined list of errands that are like post-it notes/stickies, with categories (like grocery shopping, etc.) and sub-items (i.e. for grocery shopping would have “eggs”, “milk”, “cheese”, etc, like a checklist) The user interface can look like small post-its which the user could drag to their To-do list and “stick” to it, just like a post-it note. In certain implementations, the user has the ability to text a notepad to any cell number (i.e. grocery list)

Speed buttons can be included on the dashboard to-do the following:

1. Create a Cloud speed button

2. Party/Activity/Announcement speed button

3. “Catch a Ride” (carpool) speed button

4. Find a Play date speed button

5. Need Volunteers speed button

6. Appears at the top of every page (main Navigation Menu), or in left Nay

7. Also navigates to the Manage cloud and Event area—“Content Bank”

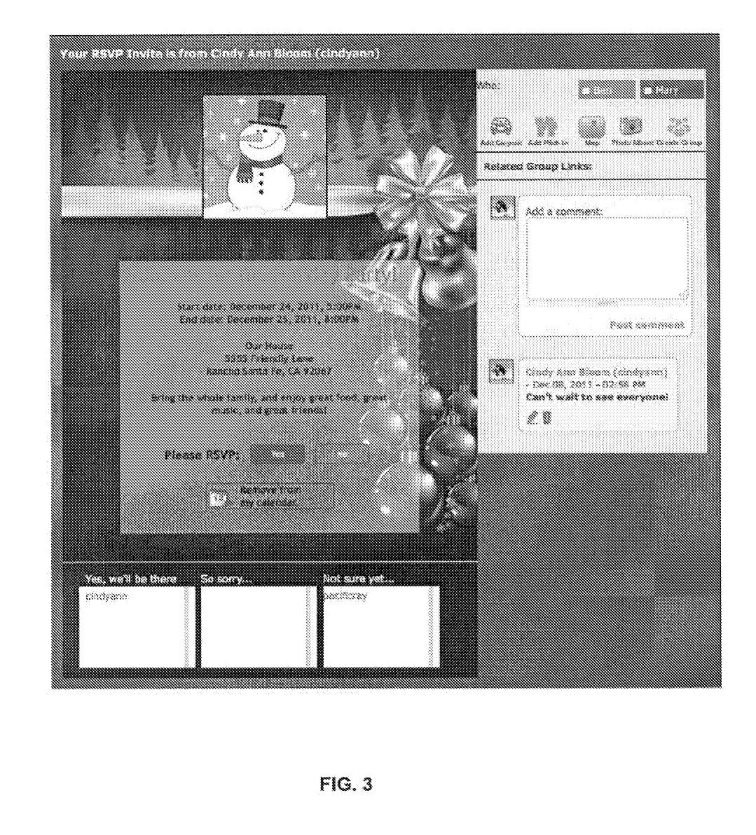

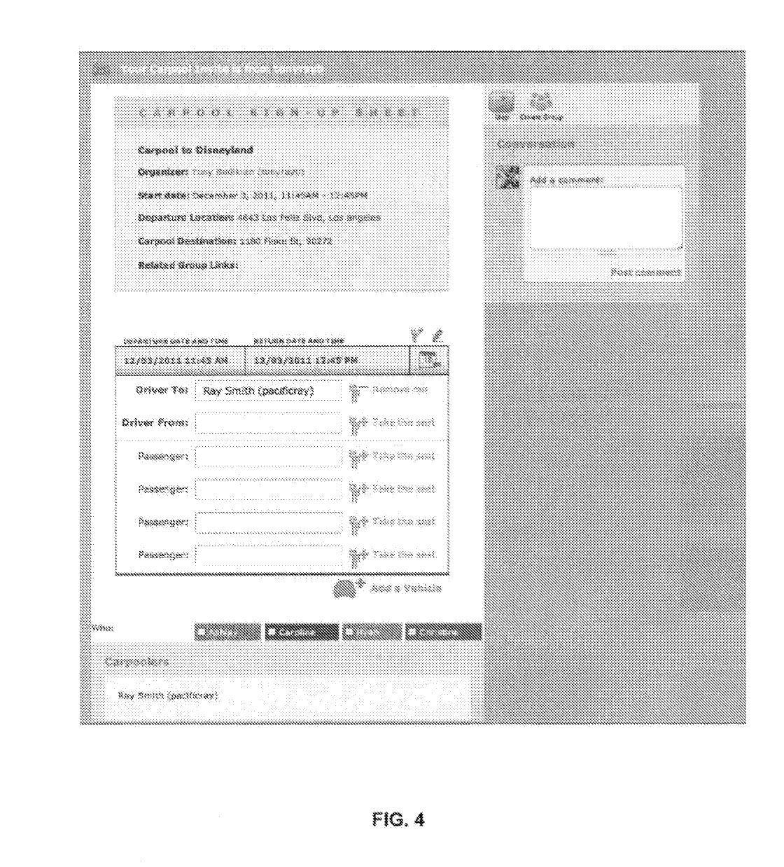

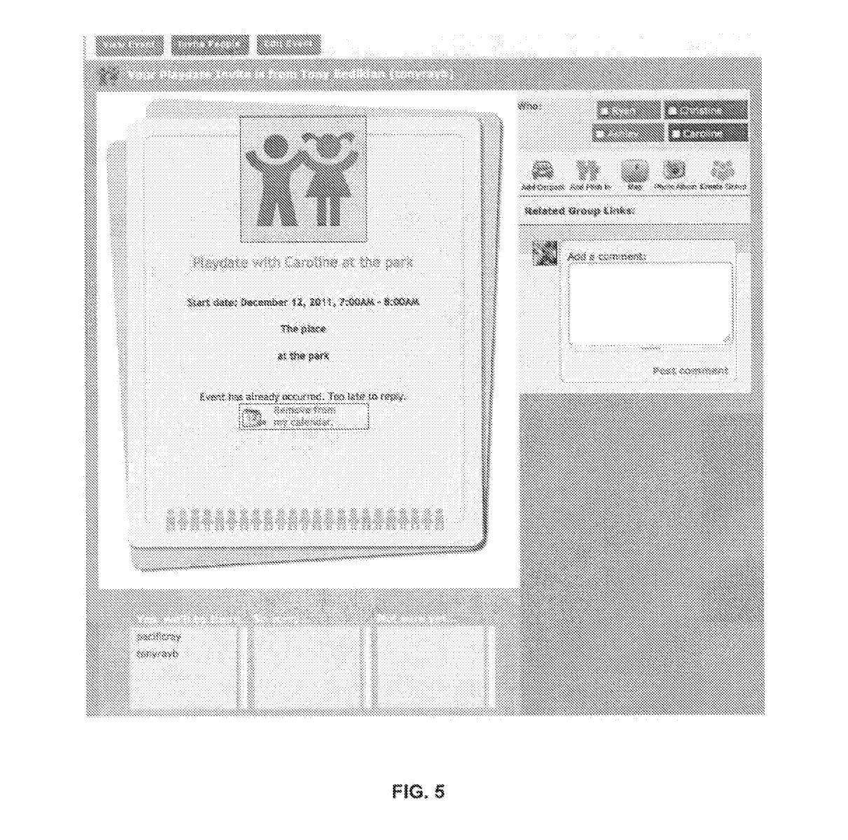

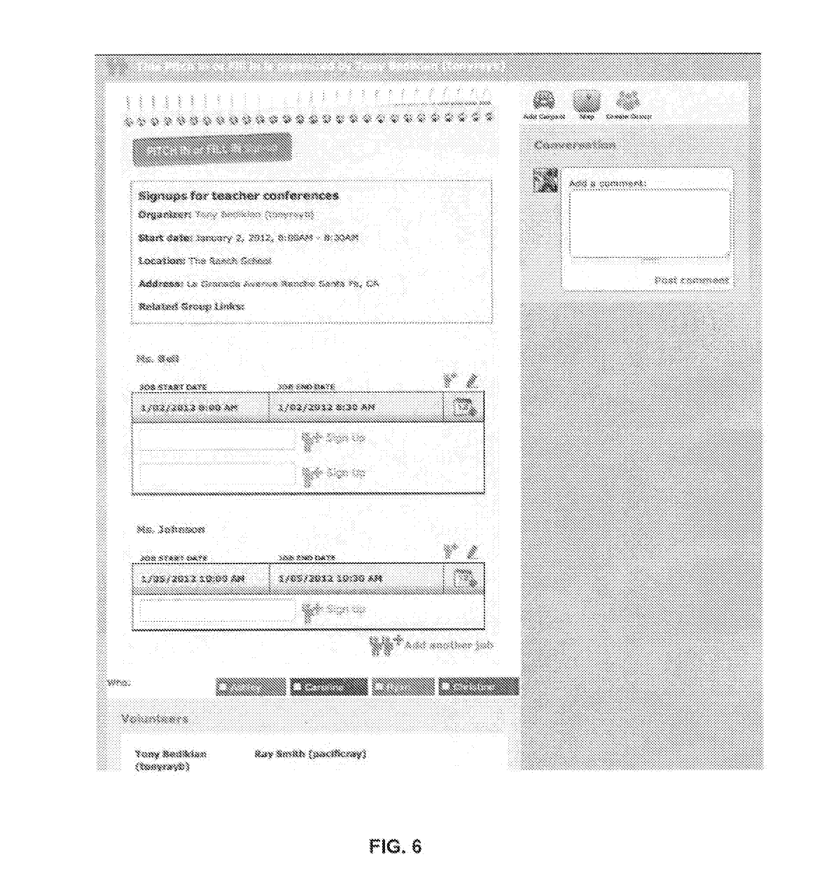

FIGS. 3-6 are screenshots illustrating example speed button screens for creating a party, a carpool, a play date and volunteer sign up.

A “Get Me some help!” Speed Button (or “Get a Helping Hand” Button) can also be included. Such a button can be included at the top of every family's dashboard which when clicked, automatically logs into the home service provider page to find a sitter/nanny, housekeeper, dog sitter, tutor, etc., or goes to registration page for Premium membership if not already a premium member.

There can also be a “Cloud Wizard” Speed button—Speed button at top of dashboard, includes “cloud manager” to organize clouds—Wizard style setup (step 1, step 2, etc.) as described earlier as well as an Event Speed buttons—Wizard style setup (step 1, step 2, etc.) and a “Party/Get-together/Announcements”, “Find a Play date”, “Catch a Ride”, “Need Volunteer—as described earlier button or buttons.

In addition to the internal emailing box in communication area, user can click on a link to their external email account (Yahoo, Gmail, Hotmail, etc.) which brings up another website tab to access their external emails conveniently.

A Last Minute Ride Blast function can also be included—i.e. need someone to take your child home from school because you're stuck in traffic. Invite blast to a cloud (i.e. your “Emergency” cloud or to specific members), wait for first person to accept, then auto cancel invite (other recipients receive invite expiration notice, “caught my ride, thx” message).

An auto invite feature can be used as noted above to allow users to invite other users to join groups, events, clouds, etc. In certain implementations, the user chooses a list of potential guests (say 15), plus number of people they actually need (say 2 people), and puts the guests in order of preference (drag guests up/down the list). The system then automatically sends out an invitation one at a time (or 2 at a time if the user chose two guests needed), and each invitation sent is open for a set amount of time, that the user chooses, before it auto-cancels (sending that guest a friendly expiration notice) and the next invite is sent, and so on. And when the number of guests needed accepts, the invitation process stops. Such a function is designed for finding play dates (given how much effort it requires to make several phone calls and wasting tons of time), but can be used for other invitation types as well. This approach can eliminate the problem of making several phone calls to a list of people for any need (play date, a work position, etc.) who may not be available, while at the same time allowing the sender to order the guest list by preference.

This approach can also be used for a “needs help fast” function. Here the user chooses a list of potential guests and number of people they actually need (no ordering of guests). The system sends the invitation to everyone (like a standard invitation), but when the predetermined number of guests chosen accepts, the invitation process auto-cancels and guests who did not respond in time are auto-sent a friendly cancellation notification. This eliminate the problem of wasting time making several phone calls when immediate help is needed to fulfill a need (i.e. pickup my son from school because I'm stuck in traffic, etc.)

A radius/map search can also be used to invite people to Carpools (and Play dates soon): The user searches for potential guests (only Friends or Group Link members) within a certain radius from the address chosen (departure location, sender's home, etc.). The system shows all potential guests on a map (with name icons on the map showing the guest name), then populates the invitation list in order of guests closest to farthest from the radius search address originally chosen. This eliminates the problem of wasting time contacting other potential carpoolers when they may not be conveniently located join the carpool (or play date).

For the Auto Invite, the challenge can be that there was no similar software built up until this point. Also, the Auto invite is a “state machine” and in addition to sending out invitations, there is a need to constantly track the state in terms of how many potential invitees are available, are remaining, and have responded with an acceptance or decline.

For the Radius Map Search, the primary challenge is integrating with the Google API.

For the Need Help functionality, the programming challenge is similar to building an email system and an emergency notification system that would be intuitive and easy to use. An added challenge is that there is a need to track responses and cancel the notification.

Radius Search Solution: To create the radius search results, the x,y (Lat and Long) coordinates of the user's address are obtained and stored. A comparison can then be run between the user's location and the search result locations to only show the search results that meet the distance (radius) requirements.

For the auto invite, the challenge was solved with several programs. The first utilizes a chron to run a program analyzing and sending invitations. Secondly, every invitation, acceptance and decline is stored in the database so that there is a snapshot of the “state” of all invitations. All of the state machine business logic is written in PHP Procedures.

For the Needs Help functionality, a similar approach was followed to the auto invite, essentially creating a state machine combined with a user response (instead of a chron) to analyze the state, process invitations, and process acceptances and declines. Whereas the auto invite runs every few minutes, the Need Help runs the instant users respond to messages by clicking links.

The signup sheet function described above is essentially an online version of a paper signup sheet that has the benefits of being accessible from any computer in one centralized location, the ease of signing up with just a click of the mouse, and automatic integration into the user's calendar and reminder system. Signup sheets are fully customizable. People invited to the signup sheets can “one-click” spots they want to signup for, and their name is auto-saved on the signup sheet, and linked to their own account so they receive all information about the signup sheet throughout its life. All signup sheets have a “conversation are” for participants to talk about the event, which is recorded directly on every signup sheet for easy reference (essentially a message board on every signup sheet).

Volunteer (“Pitch In or Fill In” or “PIFI”) signup sheets: Provides the ability to create single date/time sheets, multiple date/time sheets, or “no particular” date/time sheets for volunteer jobs available, requests to bring items to an event, or to take surveys of interest for any event the user chooses (i.e. for schools/classrooms, churches/temples, sports leagues, charities). Users (creator or recipient) simply signup for jobs, items needed, etc. directly on the signup sheet by clicking “sign up” next to a job/item.

This solves the problem of signups done via sporadic email or phone, which produces a significant number of responses for the admin that ordinarily would be manually recorded. Also makes the signup process “paperless” (for families, schools/classrooms, churches, etc). Allows the admin and the guests to easily track their signups and get reminded via their calendar and message system.

Carpool signup sheets: Provides the ability to create multiple date/time carpools, and multiple vehicle carpools, all on one signup sheet. Users (creator or recipient) simply click on Driver or Passenger seats, which auto-saves themselves (or their children) into the appropriate seats for easy recording, reference, and integration into calendar and reminder system of each user.

Solves the problem of coordination done via sporadic email or phone. Solves the problem of people being unable to coordinate carpools given lack of knowledge of each other's general location, activity schedule, or desire to carpool. Provides a centralized online place for all coordination and tracking. Allows the admin and the guests to easily track their signups and receive auto reminders via their calendar and message system.

The PIFI (and Carpool) signup page can be difficult to implement because each Pitch in has multiple jobs. It is a one to many relationships similar to an invoice header with detail lines. In the system, business logic constraints are included that allow only some members to view a pifi. If you can view it, then you can sign up to it. Also, admins (members who created it) can modify the carpool, while others can view and join. So permission issues have to be enforced at the PIFI level.

This problem was solved using Access control list “ACL” style permissions. When a Pitch in Fill in is created, a list of all system users allowed to view and sign up for a job is created. This list is then referenced when displaying the PIFI and PIFI Sign up sheet. This technology approach was leveraged to implement the carpool functionality as well.

Exhibit A attached includes further description of an example embodiment and various implementations of the operation of authority 101 and the various functions 102 described herein.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A system for filtering and managing event and activities, comprising:
a hardware processor configured to manage a site, the hardware processor further configured to
allow users to create user areas within the site;
allow the users to create various kinds of events and designate invitees through the user area;
automatically generate and send invitations to the invitees and to monitor the status of invitations;
receive invitations for the user to other events through the user area;
automatically integrate all events generated by the user, or associated with received invitations into a single calendar; and
automatically send email updates to the user related to event times, dates, invitation acceptances, and messages related to events.

2. The system of claim 1, wherein the user created events can include at least one of a To-do event, carpool, play date, volunteer event, birthday, or other special event.

3. The system of claim 1, wherein the hardware processor is further configured to allow the user to create group links associated with an event.

4. The system of claim 1, wherein the processor is configured to place an icon on the calendar related to an event, and wherein the icon is configured to links the user directly to a view associated with the event when selected.

5. The system of claim 1, wherein the processor is configured to divide the user area into quadrants and to display information in each quadrant.

6. The system of claim 5, wherein the quadrants include the calendar, To-Do's, group links, and a message center.
